(19) United States
(12) Patent Application Publication
(10) Pub. No.: US 2017/0344351 A1
(43) Pub. Date: Nov. 30, 2017

(54) INFORMATION PROCESSING APPARATUS, COMPILING MANAGEMENT METHOD, AND RECORDING MEDIUM

(71) Applicant: FUJITSU LIMITED, Kawasaki-shi (JP)

(72) Inventor: Takahiro MIYOSHI, Numazu (JP)

(73) Assignee: FUJITSU LIMITED, Kawasaki-shi (JP)

(21) Appl. No.: 15/480,862

(22) Filed: Apr. 6, 2017

(30) Foreign Application Priority Data
May 25, 2016 (JP) 2016-104685

(51) Int. Cl. G06F 9/45; G06F 9/44

(52) U.S. Cl. CPC G06F 8/443; G06F 8/72

(57) ABSTRACT

An information processing apparatus includes a memory; and a processor coupled to the memory. The processor is configured to determine, when a first file among multiple files is compiled, whether a first function defined in the first file calls a second function that includes a loop process. The second function is defined in a second file among the files and different from the first file. The processor executes at least one of: duplicating the second function and a third function into the first file, when determining that the first function calls the second function and a call to the third function defined in any of the multiple files is present in the loop process; and duplicating the second function into the first file, when determining that the first function calls the second function and a pointer type dummy parameter of the second function is referred to within the loop process.

### CROSS REFERENCE TO RELATED APPLICATIONS

This application is based upon and claims the benefit of priority of the prior Japanese Patent Application No. 2016-104685, filed on May 25, 2016, the entire contents of which are incorporated herein by reference.

### FIELD

The embodiments discussed herein relate to an information processing apparatus, a compiling management method, and a recording medium.

### BACKGROUND

A conventional optimization technique by a compiler is an optimization technique called inline expansion, which reduces overhead for calling a function by inserting a process of the called function into a reading source of the function. In another technique, when a function defined in a certain file calls another function defined in another file, the definition of the other function is duplicated to the certain file so as to facilitate the inline expansion of the other function.

In a related prior art, for example, it is evaluated whether each function is subjected to the inline expansion based on static control information obtained by analyzing and collecting intermediate text strings converted from a source code, and a corresponding inline expansion portion is restored for each call to an original function depending on the evaluation result. In another technique, a program of a function referred to by an input source file is extracted from a source library file by a compiler, combined with the input source file, and subjected to an optimization process for conversion into a machine language instruction sequence. For example, refer to Japanese Laid-Open Patent Publication Nos. H09-128246 and H05-61687.

### SUMMARY

According to an aspect of an embodiment, an information processing apparatus includes a memory; and a processor coupled to the memory. The processor is configured to determine, when a first file among multiple files is compiled, whether a first function defined in the first file calls a second function that includes a loop process, the second function being defined in a second file this is among the multiple files and different from the first file. The processor further executes at least one of: duplicating the second function and a third function into the first file, when determining that the first function calls the second function and a call to the third function defined in any of the multiple files is present in the loop process; and duplicating the second function into the first file, when determining that the first function calls the second function and a pointer type dummy parameter of the second function is referred to within the loop process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an operation example of an information processing apparatus 101 according to an embodiment;

FIG. 2 is an explanatory diagram of an example of hardware configuration of the information processing apparatus 101;

FIG. 3 is an explanatory diagram of a functional configuration example of the information processing apparatus 101;

FIG. 4 is an explanatory diagram of an example of interprocedural analysis information proc;

FIG. 5 is an explanatory diagram of an example of a source file group srcA;

FIG. 6 is an explanatory diagram of an example of an intermediate language data group intA;

FIG. 7 is an explanatory diagram of an example of interprocedural analysis information procA after call graph collection;

FIG. 8 is an explanatory diagram of an example of call graph information callA;

FIG. 9 is an explanatory diagram of an example of interprocedural analysis information procA after collection of dummy parameter information;

FIG. 10 is an explanatory diagram of an example of the interprocedural analysis information procA after loop process analysis;

FIG. 11 is an explanatory diagram of an example of the intermediate language data group intA after function duplication;

FIG. 12 is an explanatory diagram of an example of a source file group srcB;

FIG. 13 is an explanatory diagram of an example of an intermediate language data group intB;

FIG. 14 is an explanatory diagram of an example of interprocedural analysis information procB after call graph collection;

FIG. 15 is an explanatory diagram of an example of call graph information callB;

FIG. 16 is an explanatory diagram of an example of the interprocedural analysis information procB after collection of dummy parameter information;

FIG. 17 is an explanatory diagram of an example of the interprocedural analysis information procB after loop process analysis;

FIG. 18 is an explanatory diagram of an example of the intermediate language data group intB after function duplication;

FIG. 19 is a flowchart (part 1) of an example of an interprocedural optimization process procedure;

FIG. 20 is a flowchart (part 2) of the example of the interprocedural optimization process procedure; and

FIG. 21 is a flowchart (part 3) of the example of the interprocedural optimization process procedure.

### DESCRIPTION OF THE INVENTION

Embodiments of a disclosed information processing apparatus, compiling management method, and recording medium will be described in detail with reference to the accompanying drawings.

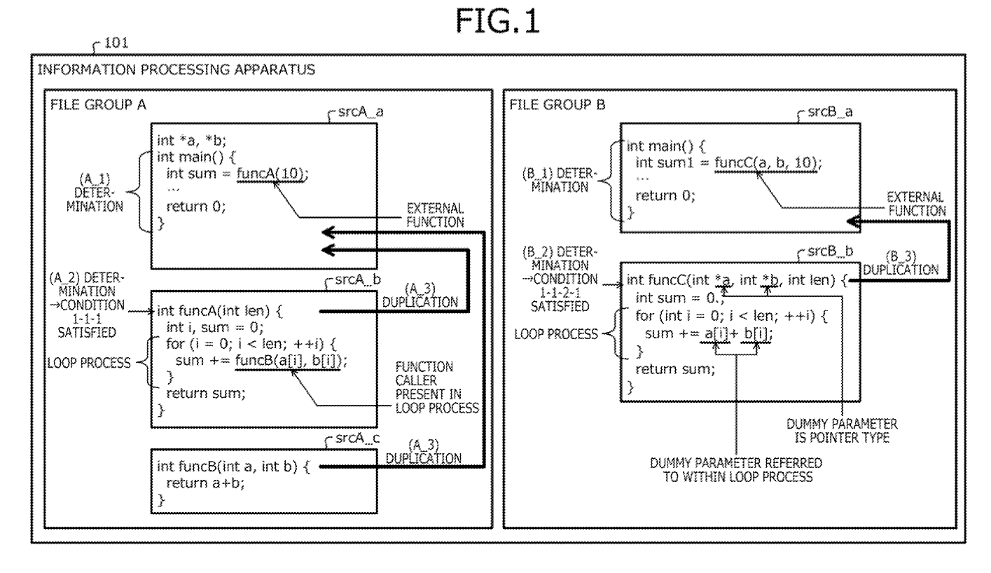

FIG. 1 is an explanatory diagram of an operation example of an information processing apparatus 101 according to the present embodiment. The information processing apparatus 101 depicted in FIG. 1 is a computer configured to perform compiling. For example, the information processing apparatus 101 compiles source code prepared by a user to create an executable file. The created executable file may be a file targeting the information processing apparatus 101 or may be a file targeting another computer. The information processing apparatus 101 is, for example, a computer used in the field of high performance computing (HPC).

One optimization technique performed by a compiler is a technique called inline expansion. Inline expansion is a technique of reducing overhead for calling of a function by inserting a process of a called function into a reading source of the function. In another technique, when a function defined in a certain file calls another function defined in another file, the definition of the other function is duplicated to the certain file so as to facilitate the inline expansion of the other function. A function defined by another file called by a function defined in a certain file will hereinafter be referred to as an “external function”. The compiler determines whether the inline expansion is to be performed for a function in the same file and therefore may facilitate the inline expansion for an external function by duplicating the definition of the function.

However, it is difficult to determine which function should be duplicated to a caller file so as to facilitate the inline expansion at the time of compiling. For example, if duplication is performed for every function, optimization is also performed for duplicated functions, resulting in an increase in translation time. Additionally, the number of assembler instructions is increased by the number of duplicated functions and, since the assembler instructions are arranged in a code area of object code, the code area of the object code increases. Therefore, as the number of duplicated functions increases, the code area of the object code is further enlarged. Thus, duplicating an external function for performing the inline expansion has a trade-off relationship with the size of the executable file.

Additionally, if the duplication is performed for every function, since it is not determined whether a function leads to an improvement in execution performance, the execution performance is not necessarily significantly improved even though inline expansion is facilitated by the duplication. For example, this is because an increase in the number of instructions due to inline expansion makes it difficult to perform instruction scheduling to change the order of instructions. The instruction scheduling is an optimization technique of preventing a stall of a pipeline by rearranging the order of instructions without changing the meaning of instructions, for example.

Since an intermediate language is included in the object code, interprocedural optimization may be implemented even at link time; however, compared to the object code created when the interprocedural optimization is not performed, the size of the object code increases. The size of the object code increases because the information collected for the interprocedural optimization is embedded in one section in the object code. As a result of an increase in the size of the object code, the amount of the disk used increases.

Therefore, in the present embodiment, if a loop process of an external function includes a function call in a caller file of the external function, the called function and the external function are duplicated, and if a pointer-type dummy parameter is referred to within a loop process, the external function is duplicated, which will be described.

The conditions of the function to be duplicated as described above will be described. First, the function to be copied is an external function. Additionally, the external function includes a loop process. The conditions also include that a function call is present in the loop process of the external function, or that a dummy parameter of an external parameter is referred to within the loop process of the external function and that the dummy parameter being referred to is of the pointer type. The dummy parameter is a variable that accepts a value passed from the caller at the time of execution and is among variables defined by the function. The pointer type is a type of a pointer to a certain data, i.e., a storage type of a value of an address of a storage device in which the certain data is stored. For example, in the case of definition “certain type name *variable” in the C language, the variable enclosed in double quotation marks is a pointer type for a certain type. For example, in the case of the definition “int *a”, a is defined as a pointer to int-type data.

Description will be made of the condition that the external function includes a loop process. The loop process is a process of repeating a process under some condition. For example, the loop process is a FOR statement or a WHILE statement. Since the loop process is a point forming a bottleneck in a program, the performance of the executable file may be improved by applying various optimizations to the loop process. On the other hand, when the external function is a function without a loop process, such as a function only obtaining a value or a function only substituting a value as in the case of getter/setter, the function is excluded from being subject to duplication because no significant effect can be obtained even if duplication is performed.

Description will be made of the condition that a function call is present in the loop process of the external function. This is because if a function call is present in the loop process of the external function, and the external function and the function present in the loop process are not subjected to the inline expansion, loop optimizations such as single instruction multiple data (SIMD) formation and automatic parallelization are no longer applied. In the following description, a condition 1-1-1 refers to the condition that a function call is present in the loop process of the external function.

Description will be made of the condition that the dummy parameter of the external parameter is referred to within the loop process of the external function and that the dummy parameter being referred to is of the pointer type. This is because if the dummy parameter being referred to within the loop process is of the pointer type, it is difficult to determine whether the storage area pointed to by the pointer overlaps another pointer-type variable, i.e., so-called alias analysis is difficult, and therefore, the loop optimizations such as SIMD formation and automatic parallelization are no longer applied. Duplicating the external function facilitate understanding of the presence/absence of a dependence relationship. In the following description, a condition 1-1-2-1 refers to the condition that the dummy parameter of the external parameter is referred to within the loop process of the external function and that the dummy parameter being referred to is of the pointer type.

In the present embodiment, a function satisfying either the condition 1-1-1 or the condition 1-1-2-1 is duplicated.

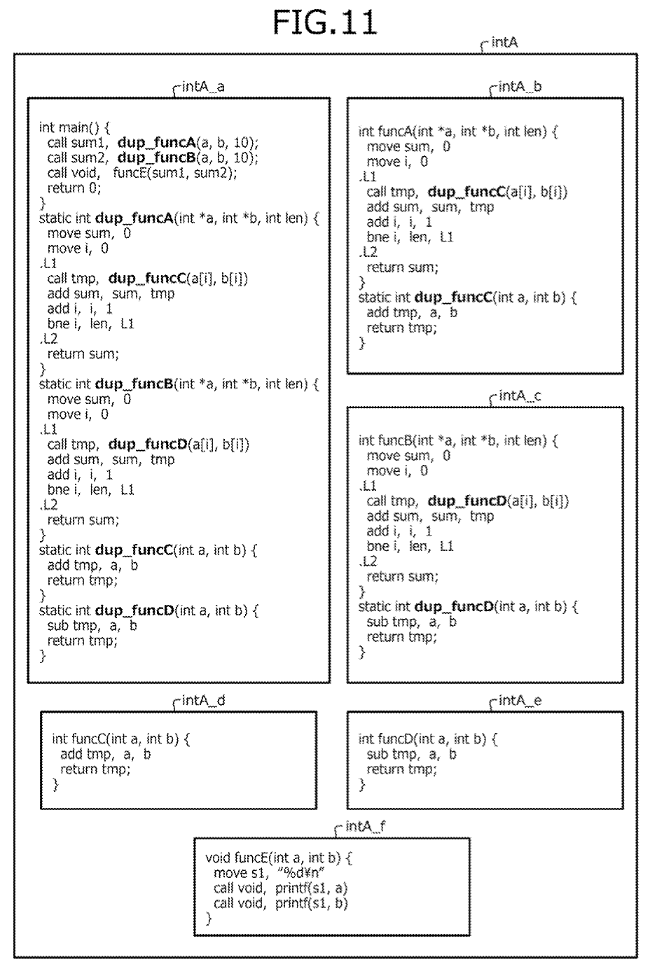

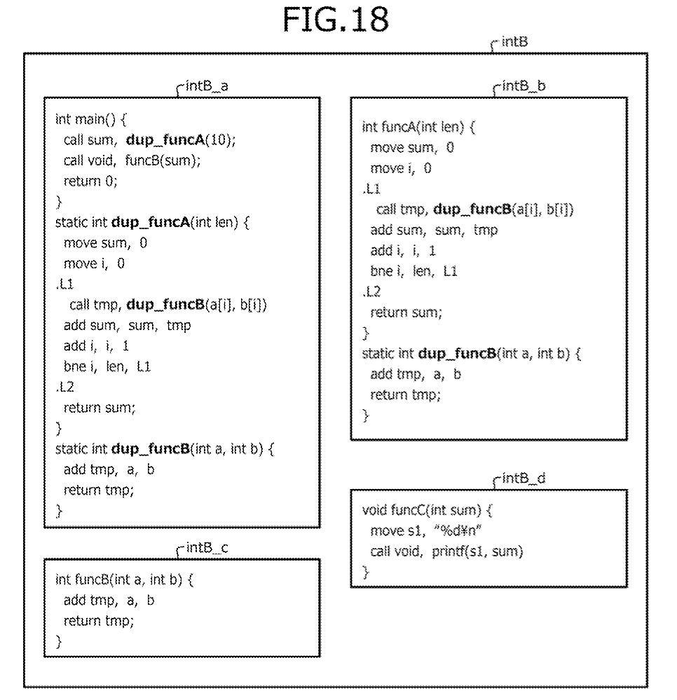

An operation example of the information processing apparatus 101 will be described with reference to FIG. 1. In FIG. 1, a source file written in the C language will be described as an example. For example, in FIG. 1, a file group A and a file group B are used for description. In this case, a duplication destination of a function to be duplicated is intermediate language data that is a file of the intermediate language converted from the source file. However, in FIG. 1, to facilitate the description of the satisfaction of the conditions 1-1-1 and 1-1-2-1, an image represented by the C language will be described as is. Examples of duplication of functions to intermediate language data are depicted in FIGS. 11 and 18.

First, compilation of the file group A will be described. The file group A includes source files srcA_a to srcA_c as multiple files. A main function, a funcA function, and a funcB function are respectively defined in the source files srcA_a to srcA_c. The main function calls the funcA function. The funcA function is defined in the file srcA_b serving as a second file different from the file srcA_a in which the main function is defined, and therefore is an external function. The funcA function includes a loop process. Additionally, the funcA function calls the funcB function within the loop process.

It is assumed that the file srcA_a is compiled as a first file in the file group A. In this case, as indicated by (A_1) in FIG. 1, the information processing apparatus 101 determines whether the first function defined in the file srcA_a calls the second function that is the external function including the loop process. In the example of the file group A of FIG. 1, the information processing apparatus 101 determines that the main function serving as the first function calls the funcA function as the second function.

If it is determined that the first function calls the second function, as indicated by (A_2) in FIG. 1, the information processing apparatus 101 determines whether either the condition 1-1-1 or the condition 1-1-2-1 is satisfied. In this case, the information processing apparatus 101 may determine whether only the condition 1-1-1 is satisfied, may determine whether only the condition 1-1-2-1 is satisfied, or may determine whether the condition 1-1-2-1 is satisfied when the condition 1-1-1 is not satisfied. Alternatively, the information processing apparatus 101 may determine whether the condition 1-1-1 is satisfied when the condition 1-1-2-1 is not satisfied, or may further determine whether the condition 1-1-1 is satisfied even when the condition 1-1-2-1 is satisfied.

When the condition 1-1-1 is represented by using the first function and the second function, a call to the third function defined in any of the multiple files is present in the loop process included in the second function. In this case, the file defining the third function may be a file defining the first function, a file defining the second function, or a file different from the file defining the first function and the file defining the second function. The third function is a function different from the first function and the second function. Similarly, when the condition 1-1-2-1 is represented by using the first function and the second function, the pointer type dummy parameter of the second function is referred to within the loop process.

In the example of the file group A of FIG. 1, the external function funcA calls the funcB function as the third function defined in the file srcA_c in the loop process and, therefore, the condition 1-1-1 is satisfied.

If the condition 1-1-1 is satisfied, as indicated by (A_3) in FIG. 1, the information processing apparatus 101 duplicates the funcA function as the second function and the funcB function as the third function to the file srcA_a. The information processing apparatus 101 may also duplicate the funcB function to the file srcA_b.

After the duplication of the funcA function and the funcB function, the information processing apparatus 101 performs the inline expansion of the funcA function and the funcB function into the main function. As described above, when the number of instructions increases due to the inline expansion, instruction scheduling becomes difficult to perform, and therefore, the information processing apparatus 101 may not perform the inline expansion of the funcA function and the funcB function into the main function.

The compiling of the file group B will be described. The file group B includes source files srcB_a and srcB_b as multiple files. In the source files srcB_a and srcB_b, a main function and a funcC function are respectively defined. The main function calls the funcC function. The funcC function is defined in the file srcB_b that is a file different from the file srcB_a in which the main function is defined, and therefore is an external function. The funcC function includes a loop process. Additionally, the funcC function refers to pointer-type dummy parameters a and b of the funcC function in the loop process.

It is assumed that the file srcB_a is compiled as the first file in the file group B. In this case, as indicated by (B_1) in FIG. 1, the information processing apparatus 101 determines whether the first function defined in the file srcB_a calls the second function that is the external function including the loop process. In the example of the file group B of FIG. 1, the information processing apparatus 101 determines that the main function serving as the first function calls the funcC function as the second function.

If it is determined that the first function calls the second function, as indicated by (B_2) in FIG. 1, the information processing apparatus 101 determines whether either the condition 1-1-1 or/and the condition 1-1-2-1 is satisfied. In the example of the file group B of FIG. 1, since the external function funcC refers to the dummy parameters a, b of the external function funcC in the loop process and the dummy parameters a, b are of the pointer type, the condition 1-1-2-1 is satisfied.

If the condition 1-1-2-1 is satisfied, as indicated by (B_3) in FIG. 1, the information processing apparatus 101 duplicates the funcC function as the second function to the file srcB_a. After the duplication of the funcC function, the information processing apparatus 101 performs the inline expansion of the funcC function into the main function. As described above, when the number of instructions increases due to the inline expansion, instruction scheduling becomes difficult to perform, and therefore, the information processing apparatus 101 may not perform the inline expansion of the funcC function into the main function.

As described above, the information processing apparatus 101 duplicates the external function satisfying the condition 1-1-1 or/and the condition 1-1-2-1. In this way, the information processing apparatus 101 may duplicate only a suitable function resulting in facilitation of optimization. Therefore, the information processing apparatus 101 increases the possibility of facilitating the loop optimization and may increase the possibility of improving the execution performance of the executable file if the duplicated function is subjected to the inline expansion, and suppresses increases in the translation time and in the size of the executable file.

The information processing apparatus 101 may reduce functions to be duplicated by narrowing down the conditions of duplication and therefore may suppress the translation time. The information processing apparatus 101 may also suppress an increase in the number of assembler instructions and therefore may suppress an increase in the code area of the object code. The information processing apparatus 101 performs duplication only for functions leading to an improvement in the execution performance and therefore may increase the possibility of improving the execution performance if the optimization is facilitated by the duplication. The information processing apparatus 101 temporarily creates a file only for intermediate language data. Since the intermediate language data is smaller in size than the object code including the intermediate language, the amount of the disk used also becomes smaller.

Although the information processing apparatus 101 outputs and reads the intermediate language data, the information processing apparatus 101 does not perform the interprocedural optimization at link time and therefore may facilitate the optimization while suppressing an increase in translation time.

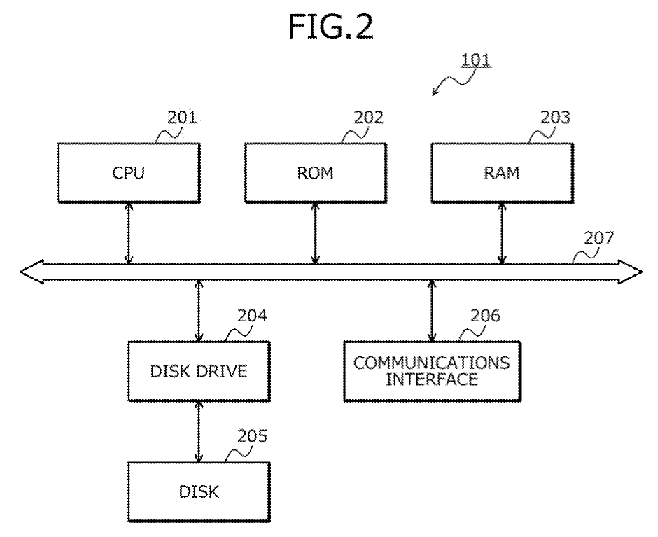

Although the C language is used as an example of the programming language in description of FIG. 1, the language may be any compiler language as long as the inline expansion is performed in the language. For example, the present embodiment is also applicable to Fortran and the C++ language. An example of a hardware configuration of the information processing apparatus 101 will be described with reference to FIG. 2.

FIG. 2 is an explanatory diagram of an example of hardware configuration of the information processing apparatus 101. In FIG. 2, the information processing apparatus 101 includes a central processing unit (CPU) 201, read-only memory (ROM) 202, and random access memory (RAM) 203. The information processing apparatus 101 further includes a disk drive 204 and a disk 205, and a communications interface 20. The CPU 201 to the disk drive 204, and the communications interface 206 are connected by a bus 207.

The CPU 201 is a computing processing apparatus that governs overall control of the information processing apparatus 101. Further, the information processing apparatus 101 may have multiple CPUs to execute parallel processing. Alternatively, the CPU 201 may have multiple cores that process SIMD. The ROM 202 is non-volatile memory that stores programs such as a boot program. The RAM 203 is volatile memory used as a work area of the CPU 201.

The disk drive 204 is a control apparatus that, under the control of the CPU 201, controls the reading and writing of data with respect to the disk 205. For example, as the disk drive 204, a magnetic disk drive, optical disk drive, solid state drive, or the like may be employed. The disk 205 is non-volatile memory that stores data written thereto under the control of the disk drive 204. For example, when the disk drive 204 is a magnetic disk drive, a magnetic disk is used as the disk 205. Further, when the disk drive 204 is an optical disk drive, an optical disk may be employed as the disk 205. Further, when the disk drive 204 is a solid state drive, semiconductor memory formed by semiconductor elements, a so-called semiconductor disk may be employed as the disk 205.

The communications interface 206 is a control apparatus that administers an internal interface with a network and controls the input and output of data from other apparatuses. In particular, the communications interface 206 is connected through a communications line, via a network, to other apparatuses such as a user terminal that uses the information processing apparatus 101. A modem or local area network (LAN) adapter may be employed as the communications interface 206, for example.

In a case where the user of the information processing apparatus 101 directly operates the information processing apparatus 101, the information processing apparatus 101 may further have hardware such as a display, a keyboard, a mouse, and the like.

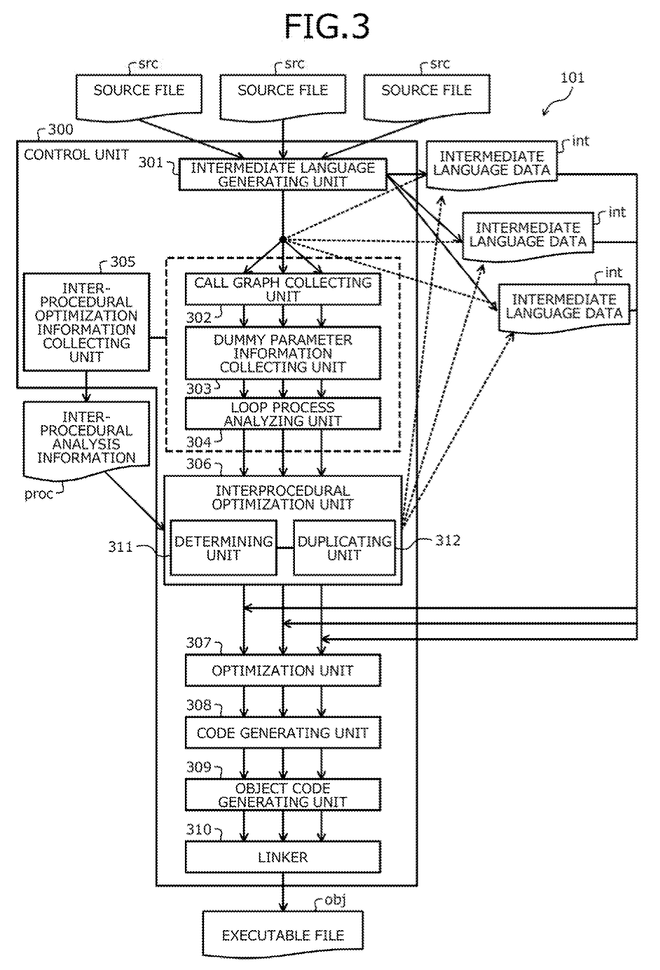

FIG. 3 is an explanatory diagram of a functional configuration example of the information processing apparatus 101. The information processing apparatus 101 has a control unit 300. The control unit 300 includes an intermediate language generating unit 301, a call graph collecting unit 302, a dummy parameter information collecting unit 303, a loop process analyzing unit 304, an interprocedural optimization information collecting unit 305, and an interprocedural optimization unit 306. The control unit 300 includes an optimization unit 307, a code generating unit 308, an object code generating unit 309, and a linker 310. The interprocedural optimization unit 306 includes a determining unit 311 and a duplicating unit 312.

The control unit 300 implements the functions of the units by the CPU 201 executing programs stored in a storage device. For example, the storage device is the ROM 202, the RAM 203, the disk 205, etc. depicted in FIG. 2. The process results of the units are stored to the RAM 203, a register of the CPU 210, a cache memory of the CPU 201, etc.

The information processing apparatus 101 may access a source file src, and the source file src is stored in the storage device such as the RAM 203 and the disk 205.

The intermediate language generating unit 301 analyzes and then converts the source file src into an intermediate language specific to the compiler. Subsequently, the intermediate language generating unit 301 outputs a file called intermediate language data int obtained by the intermediate language generating unit 301. For example, the intermediate language generating unit 301 outputs the intermediate language data int to the RAM 203.

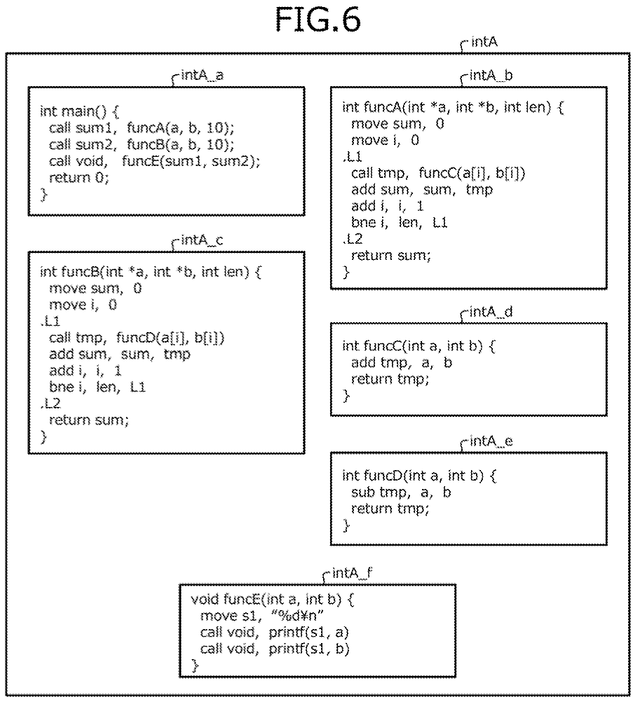

If the interprocedural optimization is performed, the units from the call graph collecting unit 302 to the loop process analyzing unit 304 encompassed by a broken line in FIG. 3 perform the following processes. On the other hand, if the interprocedural optimization is not performed, the units from the call graph collecting unit 302 to the loop process analyzing unit 304 do not perform the processes, and the optimization unit 307 performs processes. A method of determining whether interprocedural optimization is performed will be described with reference to FIG. 6.

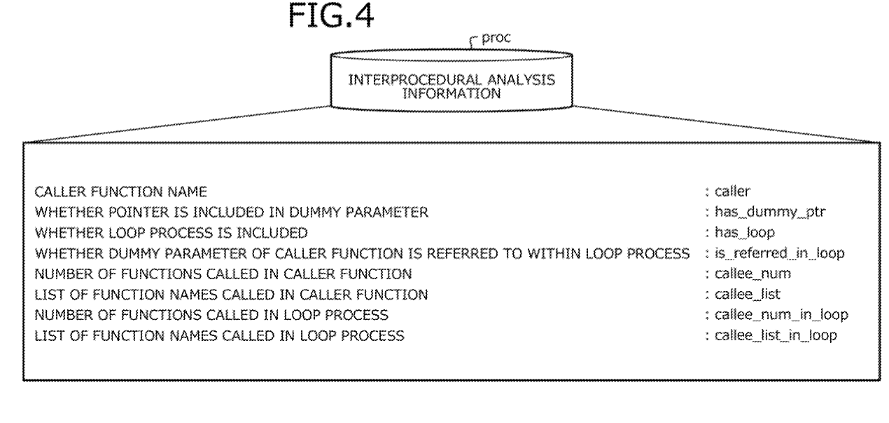

The call graph collecting unit 302 collects information of a call graph. The call graph is a diagram depicting calling relationships between functions. The dummy parameter information collecting unit 303 analyzes a statement declaring or defining a function and collects information concerning a dummy parameter. The loop process analyzing unit 304 collects information concerning whether a loop process is present in a function, whether a dummy parameter is referred to within the loop process, and a function called in the loop process. The interprocedural optimization information collecting unit 305 configures the information collected by the units from the call graph collecting unit 302 to the loop process analyzing unit 304 as interprocedural analysis information proc. A specific example of the interprocedural analysis information proc will be described with reference to FIG. 4.

The interprocedural optimization unit 306 performs function duplication for the intermediate language data int based on the interprocedural analysis information proc. The functions of the determining unit 311 and the duplicating unit 312 included in the interprocedural optimization unit 306 will be described.

The determining unit 311 refers to the interprocedural analysis information proc to determine whether a first function defined in any intermediate language data int among multiple intermediate language data int to be compiled calls a second function that is an external function including a loop process.

If it is determined that the first function calls the second function, the determining unit 311 determines whether the condition 1-1-1 or/and the condition 1-1-2-1 is satisfied. For example, the condition 1-1-1 is the condition that a third function defined in the intermediate language data int different from the intermediate language data int defining the first function is present in the loop process included in the second function. The condition 1-1-2-1 is the condition that the pointer-type dummy parameter of the second function is referred to within the loop process included in the second function.

If it is determined that the condition 1-1-1 is satisfied, the duplicating unit 312 duplicates the second function and the third function to the intermediate language data int defining the first function. In this case, if the third function is already defined in the intermediate language data int defining the first function, the duplicating unit 312 does not duplicate the third function to the intermediate language data int defining the first function. Additionally, if it is determined that the condition 1-1-1 is satisfied, the duplicating unit 312 may duplicate the third function to the intermediate language data int defining the second function. In this case, if the third function is already defined in the intermediate language data int defining the second function, the duplicating unit 312 does not duplicate the third function to the intermediate language data int defining the second function.

The determining unit 311 may determine whether the condition 1-1-1 is satisfied even if the condition 1-1-2-1 is satisfied. This is because a function call may possibly be present in the loop process of the external function satisfying the condition 1-1-2-1.

If it is determined that the condition 1-1-2-1 is satisfied, the duplicating unit 312 duplicates the second function to the intermediate language data int defining the first function.

The duplicating unit 312 excludes the main function from being subject to duplication. Additionally, the duplicating unit 312 makes a duplicated function referable only in a duplication destination file and disables reference from the other files. A specific example of duplication will be described with reference to FIGS. 11 and 18.

The optimization unit 307 performs optimization for the intermediate language data int obtained from the source file src if the interprocedural optimization is not performed, and performs optimization for the intermediate language data int to which the function duplication is applied if the interprocedural optimization is performed. For example, the optimization unit 307 performs the inline expansion described above and the instruction scheduling as the optimization.

The code generating unit 308 generates an assembly from a sequence of instructions to which various optimizations are performed. The object code generating unit 309 generates an object code from the assembly obtained by the code generating unit 308. The linker 310 generates an executable file obj from the object code.

FIG. 4 is an explanatory diagram of an example of the interprocedural analysis information proc. As depicted in FIG. 4, the interprocedural analysis information proc is analysis information for each function and has, for example, eight pieces of analysis information stored for one function.

A first piece of the analysis information is caller. Caller is set to a target caller function name. A second piece of the analysis information is has_dummy_ptr. “has_dummy_ptr” is set to true if a pointer is included in a dummy parameter, or false if not included. A third piece of the analysis information is has_loop. “has_loop” is set to true if a loop process is included in the caller function, or false if not included. A fourth piece of the analysis information is is_referred_in_loop. “is_referred_in_loop” is set to true if the dummy parameter of the caller function is referred to within the loop process, or false if not referred to.

A fifth piece of the analysis information is callee_num. “callee_num” is set to the number of functions called in the caller function. A sixth piece of the analysis information is callee_list. “callee_list” is set to a list of function names called in the caller function. A seventh piece of the analysis information is callee_num_in_loop. “callee_num_in_loop” is set to the number of functions called in the loop process in the caller function. An eighth piece of the analysis information is callee_list_in_loop. “callee_list_in_loop” is set to a list of function names called in the loop process.

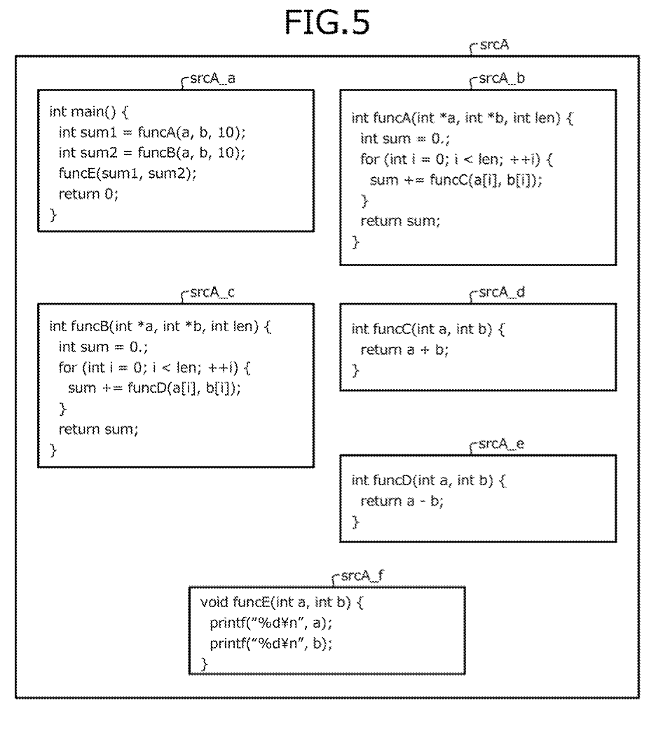

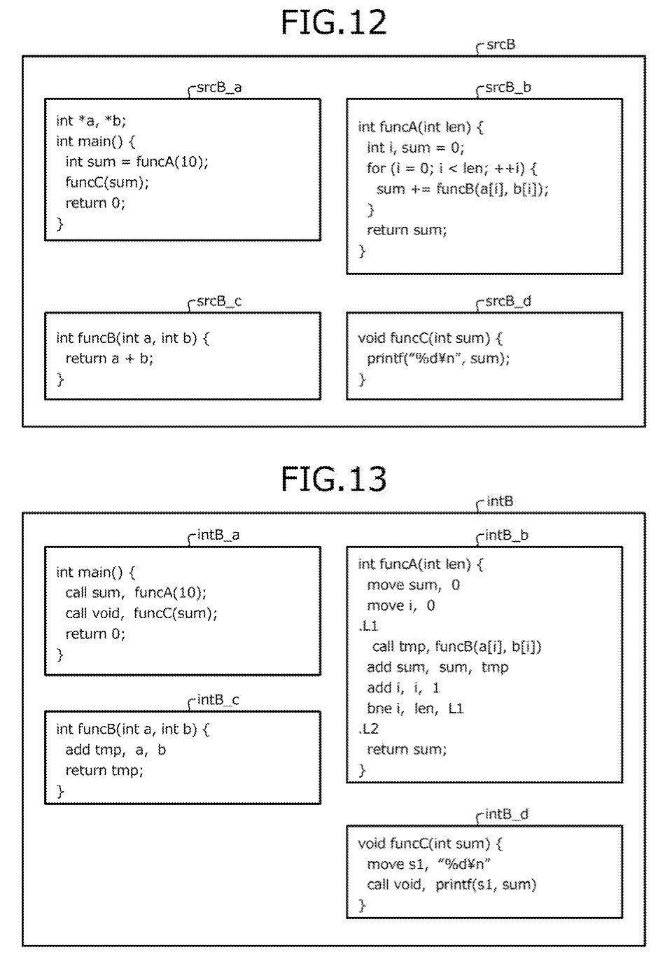

Procedures of the information processing apparatus 101 generating the intermediate language data will be described by using source file groups srcA, srcB serving as two samples. For Example 1, the source file group srcA will be described with reference to FIGS. 5 to 11, and for Example 2, the source file group srcB will be described with reference to FIGS. 12 to 18.

FIG. 5 is an explanatory diagram of an example of the source file group srcA. As depicted in FIG. 5, the source file group srcA includes source files srcA_a to srcA_f. In the source files srcA_a to srcA_f, a main file, a funcA function, a funcB function, a funcC function, a funcD function, and a funcE function are respectively defined.

The main function calls the funcA function, the funcB function, and the funcE function as external functions. The funcA function includes a loop process and calls the funcC function in the loop process. The funcB function includes a loop process and calls the funcD function in the loop process. The funcC function is a function that returns a value obtained by adding a dummy parameter b to a dummy parameter a. The funcD function is a function that returns a value obtained by subtracting the dummy parameter b from the dummy parameter a. The funcE function is a function that displays the values of the dummy parameter a and the dummy parameter b. Therefore, the funcE function called in the main function is a function that displays a result.

FIG. 6 is an explanatory diagram of an example of an intermediate language data group intA. The information processing apparatus 101 converts the source files srcA_a to srcA_e into intermediate language data. Intermediate language data intA_a to intA_f included in the intermediate language data group intA depicted in FIG. 6 are those respectively obtained by converting the source files srcA_a to srcA_f into intermediate language data. Although actual intermediate language data is handled as binary data, the binary data is depicted in a state of being converted into a readable form in the description herein for simplification of description.

Subsequently, the information processing apparatus 101 determines whether to perform the interprocedural optimization. For example, the information processing apparatus 101 determines whether to perform the interprocedural optimization through a compile option at compile time. For example, if the following command is executed at the time of compiling source files a.c, b.c, c.c, the information processing apparatus 101 determines that the interprocedural optimization is to be performed.

$ dry a.c b.c c.c -o executable file -IPO

In this case, “drv” is a compiler driver. Additionally, “-IPO” is a compile option of performing the interprocedural optimization.

When determining not to perform the interprocedural optimization, the information processing apparatus 101 applies compiler optimization to the intermediate language data group intA to create the executable file obj. On the other hand, when the interprocedural optimization is to be performed, the information processing apparatus 101 executes a call graph collecting process for the intermediate language data group intA.

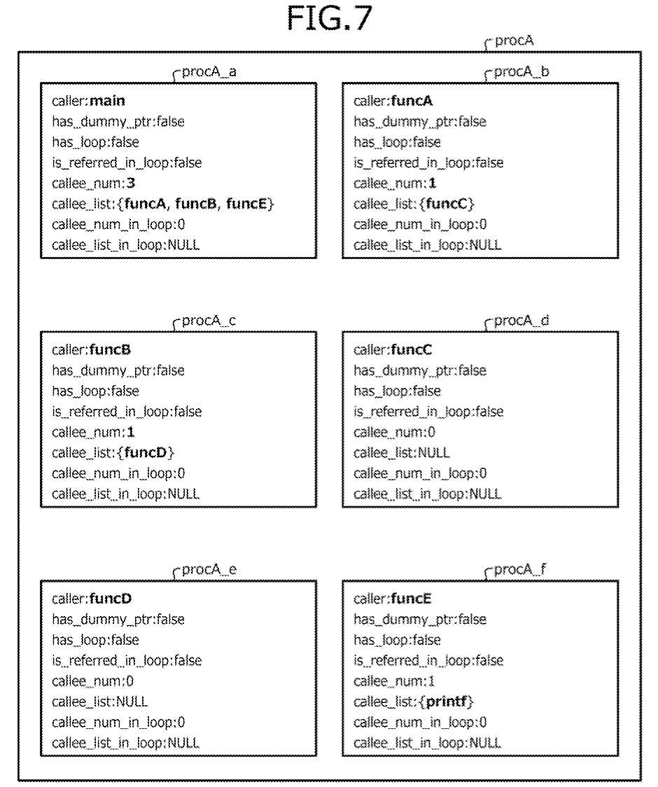

FIG. 7 is an explanatory diagram of an example of interprocedural analysis information procA after the call graph collection. The interprocedural analysis information procA depicted in FIG. 7 is an example of the interprocedural analysis information proc after the call graph collection. Pieces of interprocedural analysis information procA_a to procA_f included in the interprocedural analysis information procA are respective pieces of interprocedural analysis information of the intermediate language data intA_a to intA_f.

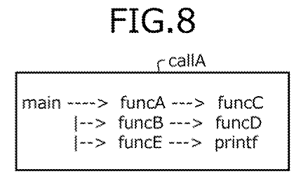

The information processing apparatus 101 sets only the relationship between a caller function and a callee function among the pieces of the analysis information of the interprocedural analysis information proc. Therefore, the information processing apparatus 101 sets has_dummy_ptr, has loop, and is_referred_in_loop to an initial value false. If no calling function is present, the information processing apparatus 101 sets callee_num to zero and sets callee_list to NULL. If the calling functions overlap, the information processing apparatus 101 considers the functions to be the same. In FIG. 7, portions indicated in bold are those changed from the initial values. From the interprocedural analysis information procA depicted in FIG. 7, call graph information callA depicted in FIG. 8 is obtained.

FIG. 8 is an explanatory diagram of an example of the call graph information callA. As can be seen from the call graph information callA depicted in FIG. 8, the main function calls the funcA function, the funcB function, and the funcE function. Similarly, as can be seen from the call graph information callA, the funcA function calls the funcC function, the funcB function calls the funcD function, and the funcE function calls a printf function.

If the call graph information callA includes a recursive call, the information processing apparatus 101 adds a symbol indicative of a recursive call. In the case of mutual recursion in such a manner that the function A calls the function B while the function B calls the function A, the information processing apparatus 101 adds a symbol indicating that the function A and the function B call each other. In some cases, the function A may call the function B, the function B may call the function C, and the function C may call the function A. In this case, the information processing apparatus 101 performs display between the function A and the function B as well as between the function B and the function C as depicted in FIG. 8 and additionally draws an arrow from the function C to the function A. The information processing apparatus 101 then collects dummy parameter information.

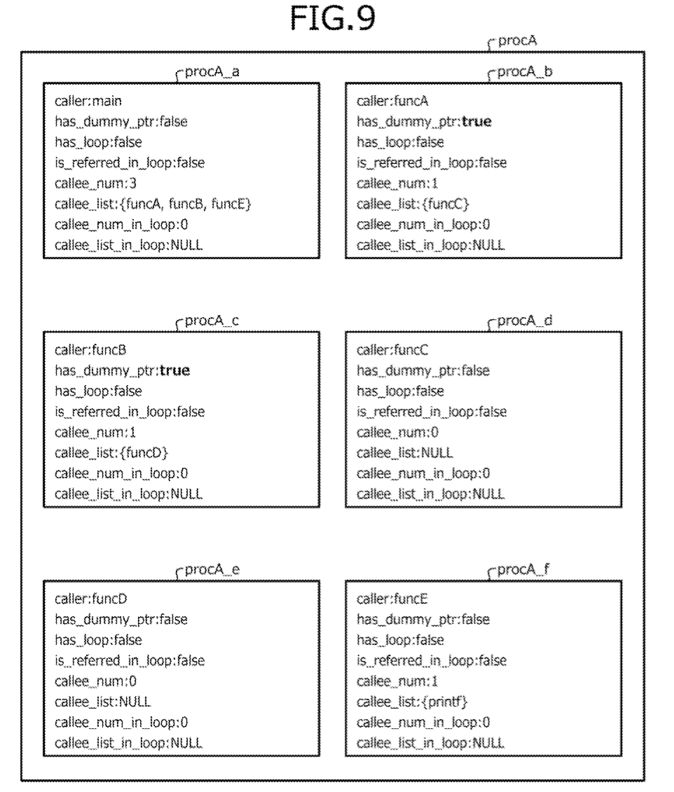

FIG. 9 is an explanatory diagram of an example of the interprocedural analysis information procA after collection of dummy parameter information. The interprocedural analysis information procA depicted in FIG. 9 is an example of the interprocedural analysis information proc after collection of dummy parameter information.

No pointer is included in the dummy parameters of the main function, the funcC function, the funcD function, or the funcE function and thus, has_dummy_ptr of the interprocedural analysis information proc corresponding to each of the functions does not change from false. On the other hand, since pointers are included in the dummy parameters of the funcA function and the funcB function, the information processing apparatus 101 sets has_dummy_ptr of ProcA_b and ProcA_c to true. In the following figures, portions indicated in bold are those changed from the initial values. The information processing apparatus 101 subsequently performs loop process analysis.

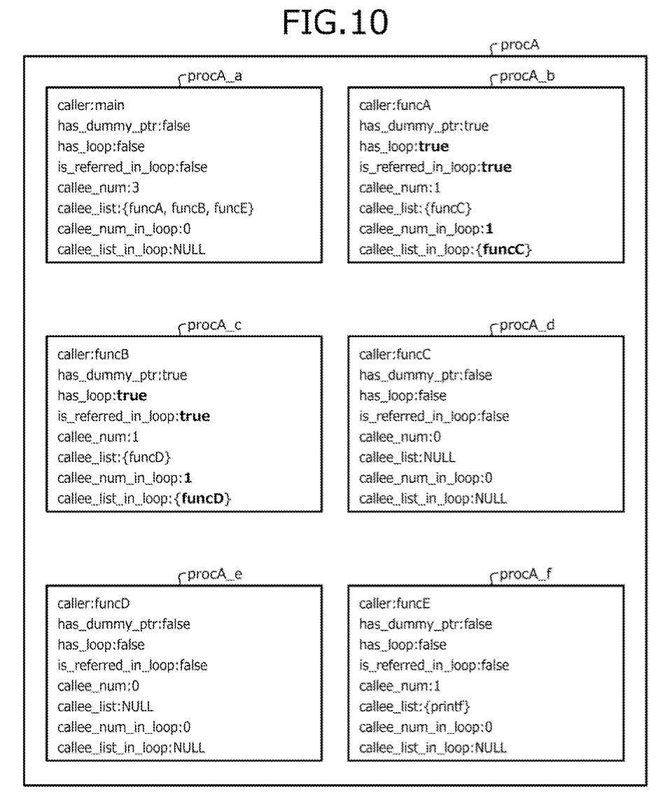

FIG. 10 is an explanatory diagram of an example of the interprocedural analysis information procA after the loop process analysis. The interprocedural analysis information procA depicted in FIG. 10 is an example of the interprocedural analysis information proc after the loop process analysis.

The main function, the funcC function, and the funcD function do not include a loop process and do not refer to a dummy parameter in a loop process; and thus, has_loop and is_referred_in_loop of the interprocedural analysis information proc corresponding to each of the functions do not change from false. On the other hand, funcA and funcB include loop processes, refer to dummy parameters in the loop processes, and call the funcC function and the funcD function, respectively, in the loop processes. Therefore, the information processing apparatus 101 sets has_loop and is_referred_in_loop of interprocedural analysis information placA_b, placA_c to true. The information processing apparatus 101 also sets callee_num_in_loop of the interprocedural analysis information placA_b, placA_c to one. The information processing apparatus 101 then sets callee_num_in_loop of the interprocedural analysis information placA_b to {funcC} and sets callee_num_in_loop of the interprocedural analysis information placA_c to {funcD}.

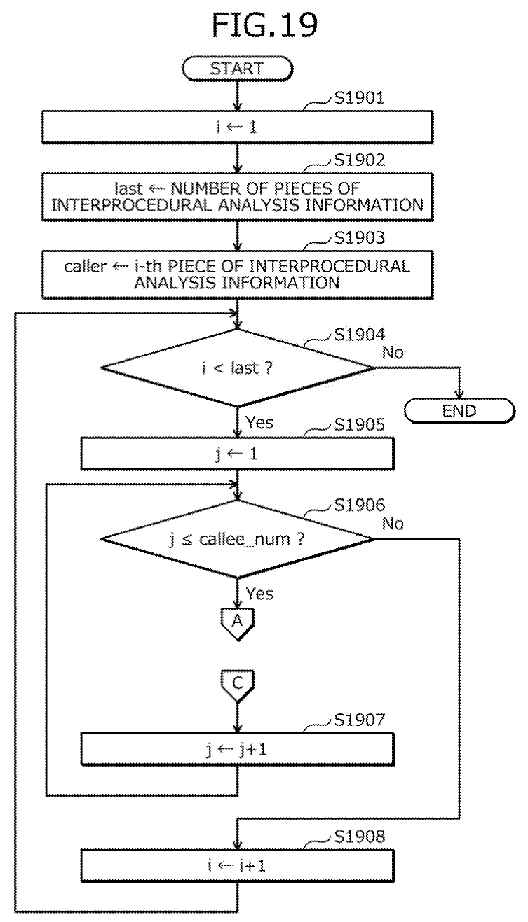

The information processing apparatus 101 subsequently executes an interprocedural optimization process by using the interprocedural analysis information ProcA depicted in FIG. 10. A specific example of the interprocedural optimization process is depicted in FIGS. 19 to 21.

FIG. 11 is an explanatory diagram of an example of the intermediate language data group intA after the function duplication. The intermediate language data group intA depicted in FIG. 11 is an example of the intermediate language data group int after the function duplication through the interprocedural optimization process. For example, the funcA function and the funcB function have pointers included in the dummy parameters and the dummy parameters referred to within the loop processes and therefore satisfy the condition 1-1-2-1. Thus, the information processing apparatus 101 duplicates the funcA function and the funcB function to the intermediate language data intA_a. On the other hand, the funcE function does not satisfy the condition 1-1-2-1 and is therefore excluded from being subject to the function duplication.

At the time of duplication, a duplicated function is made referable only at the duplication destination file, and the reference from the other files is disabled. These two processes are processes for preventing function names from conflicting. Although it is generally only necessary to either make the function referable only in the file of the duplication destination or disable the reference from the other files, it is preferable that both be performed depending on a compiler. In the example depicted in FIG. 11, “static” indicates that the file is made referable only in the duplication destination file. The duplicated function is changed to a name different from the duplication source function. In the example depicted in FIG. 11, the information processing apparatus 101 adds a prefix “dup-” to the duplication source function to change the function name of the duplicated function to a name different from the duplication source function. Alternatively, the information processing apparatus 101 may add a hash value to the duplication source function and change the function name of the duplicated function to a name different from the duplication source function.

The funcA function and the funcB function call the functions funcC function and funcD function in loop processes and therefore satisfy the condition 1-1-1. Thus, the information processing apparatus 101 duplicates the funcC function to the intermediate language data intA_a, intA_b, and duplicates the funcD function to the intermediate language data intA_a, intA_c. The main function itself is excluded from being subject to duplication. Through the processes described above, the information processing apparatus 101 obtains the intermediate language data group intA depicted in FIG. 11.

FIG. 12 is an explanatory diagram of an example of the source file group srcB. As depicted in FIG. 12, the source file group srcB includes source files srcB_a to srcB_d. In the source files srcB_a to srcB_d, a main file, a funcA function, a funcB function, and a funcC function are respectively defined.

The main function calls the funcA function and the funcC function as external functions. The funcA function includes a loop process and calls the funcB function in the loop process. The funcB function is a function that returns a value obtained by adding a dummy parameter b to a dummy parameter a. The funcC function is a function that displays a value of a dummy parameter sum. Therefore, the funcC function called in the main function is a function that displays a result.

FIG. 13 is an explanatory diagram of an example of an intermediate language data group intB. The information processing apparatus 101 converts the source files srcB_a to srcB_d into intermediate language data. Intermediate language data intB_a to intB_d included in the intermediate language data group intB depicted in FIG. 13 are those respectively obtained by converting the source files srcB_a to srcB_d into intermediate language data.

As in Example 1, the information processing apparatus 101 subsequently determines whether to perform the interprocedural optimization. When determining not to perform the interprocedural optimization, the information processing apparatus 101 applies compiler optimization to the intermediate language data group intB to create an executable file. On the other hand, when the interprocedural optimization is to be performed, the information processing apparatus 101 executes a call graph collecting process for the intermediate language data group intB.

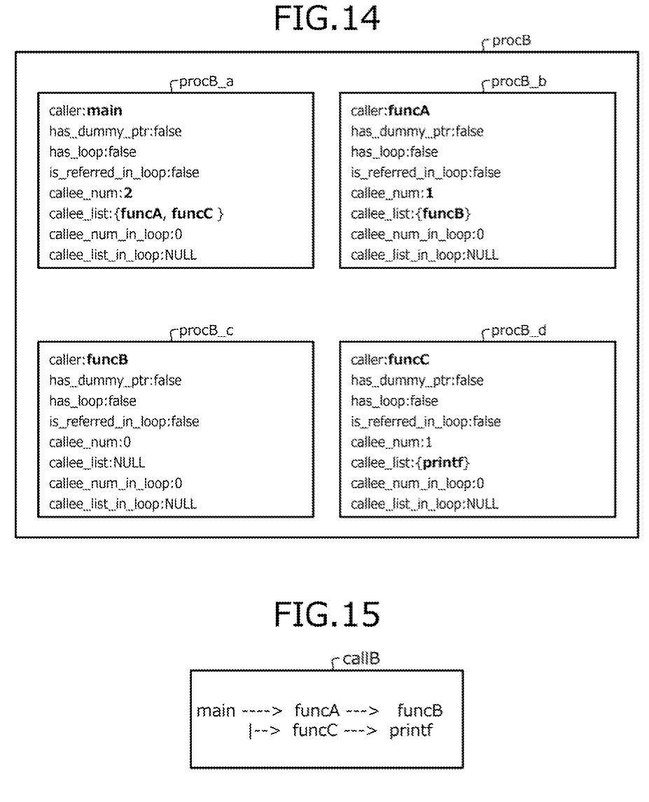

FIG. 14 is an explanatory diagram of an example of interprocedural analysis information procB after the call graph collection. The interprocedural analysis information procB depicted in FIG. 14 is an example of the interprocedural analysis information proc after the call graph collection. Pieces of interprocedural analysis information procB_a to procB_d included in the interprocedural analysis information procB are respective pieces of interprocedural analysis information of the intermediate language data intB_a to intB_d.

In FIG. 14, portions indicated in bold are those changed from the initial values. From the interprocedural analysis information procB depicted in FIG. 14, call graph information callB depicted in FIG. 15 is obtained.

FIG. 15 is an explanatory diagram of an example of the call graph information callB. As can be seen from the call graph information callB depicted in FIG. 15, the main function calls the funcA function and the funcB function. Similarly, as can be seen from the call graph information callB, the funcA function calls the funcB function, and the funcC function calls a printf function. The information processing apparatus 101 then collects dummy parameter information.

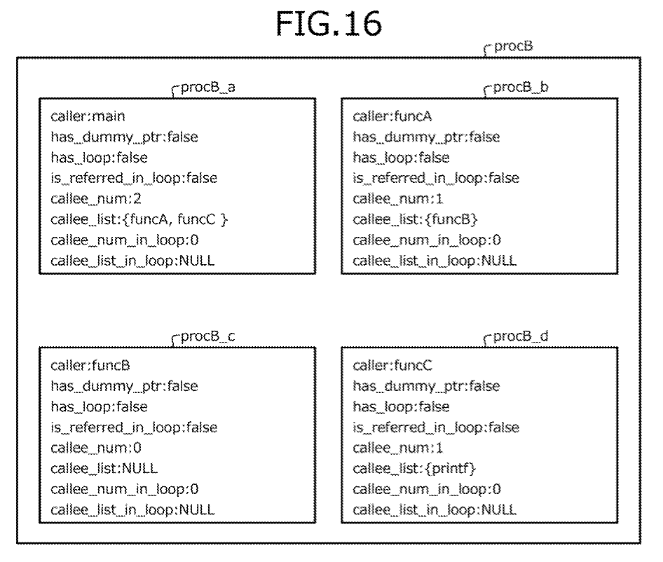

FIG. 16 is an explanatory diagram of an example of the interprocedural analysis information procB after collection of dummy parameter information. The interprocedural analysis information procB depicted in FIG. 16 is an example of the interprocedural analysis information proc after collection of dummy parameter information.

No pointer is included in the dummy parameters of the main function, the funcA function, the funcB function, or the funcC function and thus, has_dummy_ptr of the interprocedural analysis information proc corresponding to each of the functions does not change from false. Therefore, in FIG. 16, the values do not change from the state depicted in FIG. 14.

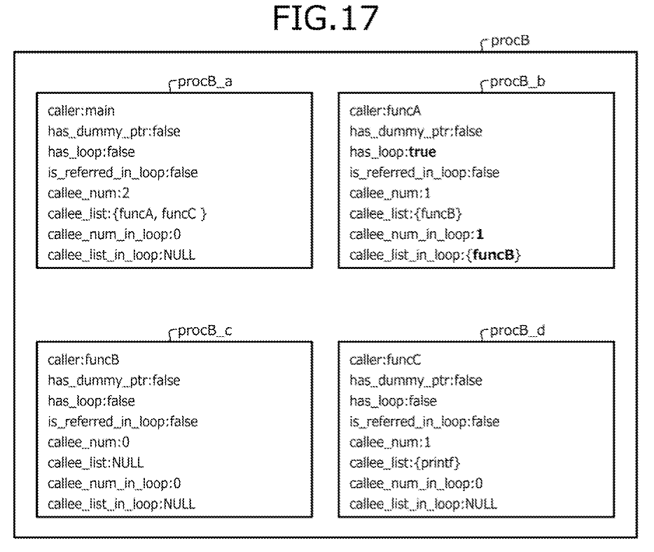

FIG. 17 is an explanatory diagram of an example of the interprocedural analysis information procB after the loop process analysis. The interprocedural analysis information procB depicted in FIG. 17 is an example of the interprocedural analysis information proc after the loop process analysis.

The main function, the funcB function, and the funcC function do not include a loop process and do not refer to a dummy parameter in a loop process; and thus, has_loop and is_referred_in_loop of the interprocedural analysis information proc corresponding to each of the functions do not change from false. On the other hand, funcA includes a loop process and calls the funcB function in the loop process. Therefore, the information processing apparatus 101 sets has_loop of interprocedural analysis information placB_b to true. The information processing apparatus 101 also sets callee_num_in_loop of the interprocedural analysis information placB_b to one. The information processing apparatus 101 then sets callee_num_in_loop of the interprocedural analysis information placB_b to {funcB}.

The information processing apparatus 101 subsequently executes an interprocedural optimization process by using the interprocedural analysis information ProcB depicted in FIG. 17. A specific example of the interprocedural optimization process is depicted in FIGS. 19 to 21.

FIG. 18 is an explanatory diagram of an example of the intermediate language data group intB after the function duplication. The intermediate language data group intB depicted in FIG. 18 is an example of the intermediate language data group int after the function duplication through the interprocedural optimization process.

The funcA function satisfies the condition 1-1-1 because although not having a pointer-type parameter, the function includes a loop process and calls a function in the loop process. Therefore, the information processing apparatus 101 duplicates the funcA function to the intermediate language data intB_a. The information processing apparatus 101 duplicates the funcB called in the loop process of funcA to the intermediate language data intB_a, intB_b.

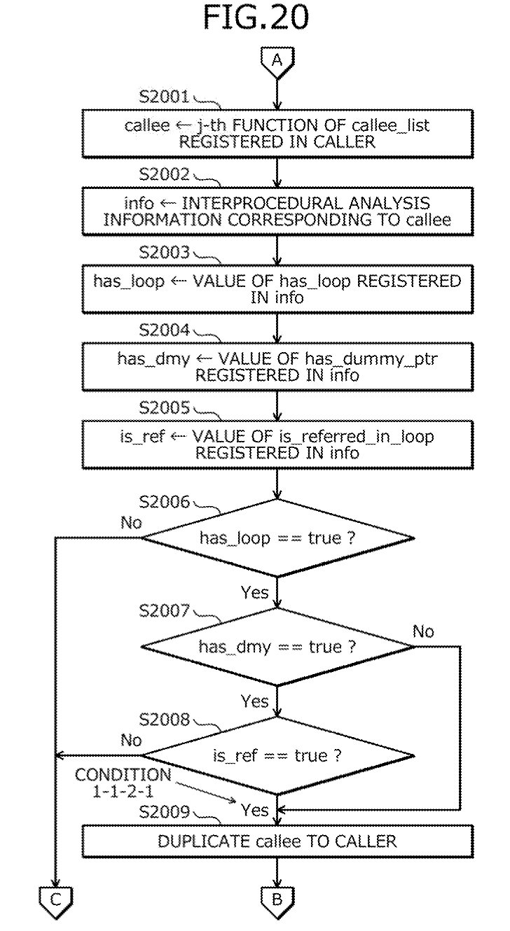

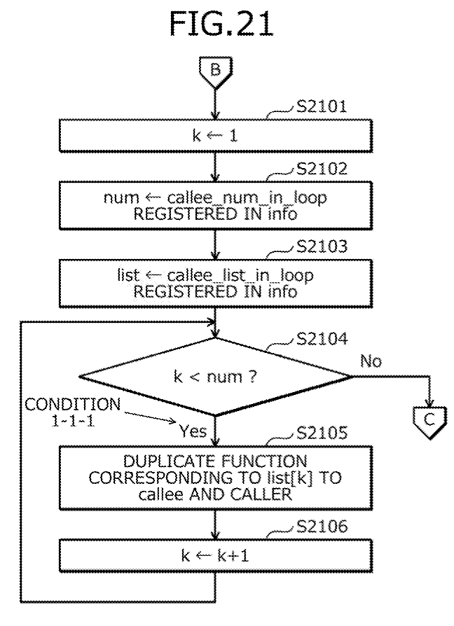

FIG. 19 is a flowchart (part 1) of an example of an interprocedural optimization process procedure. FIG. 20 is a flowchart (part 2) of the example of the interprocedural optimization process procedure. FIG. 21 is a flowchart (part 3) of the example of the interprocedural optimization process procedure.

The information processing apparatus 101 substitutes one for a variable i (step S1901). The information processing apparatus 101 substitutes the number of pieces of the interprocedural analysis information proc for a variable last (step S1902). The information processing apparatus 101 then substitutes an i-th piece of the interprocedural analysis information proc for a variable caller (step S1903).

The information processing apparatus 101 then determines whether i is less than last (step S1904). If i is equal to or greater than last (step S1904: NO), the information processing apparatus 101 terminates the interprocedural optimization process. On the other hand, if i is less than last (step S1904: YES), the information processing apparatus 101 substitutes one for a variable j (step S1905). The information processing apparatus 101 then determines if j is equal to or less than callee_num (step S1906). In this case, callee_num is callee_num of the interprocedural analysis information proc registered in caller.

If j is equal to or less than callee_num (step S1906: YES), as depicted in FIG. 20, the information processing apparatus 101 substitutes a j-th function of callee_list registered in caller for a variable callee (step S2001). The information processing apparatus 101 substitutes the interprocedural analysis information proc corresponding to callee for a variable info (step S2002). The information processing apparatus 101 substitutes the value of has_loop registered in info for a variable has_loop (step S2003). The information processing apparatus 101 substitutes the value of has_dummy_ptr registered in info for a variable has_dmy (step S2004). The information processing apparatus 101 also substitutes the value of is_referred_in_loop registered in info for a variable is_ref (step S2005).

The information processing apparatus 101 then determines whether the value of has_loop is true (step S2006). If the value of has_loop is true (step S2006: YES), the information processing apparatus 101 subsequently determines whether the value of has_dmy is true (step S2007). If the value of has_dmy is true (step S2007: YES), the information processing apparatus 101 subsequently determines whether the value of is_ref is true (step S2008).

If the value of has_dmy is not true (step S2007: NO) or if the value of is_ref is true (step S2008: YES), the information processing apparatus 101 duplicates callee to the caller (step S2009). The case of “YES” at step S2008 represents a case where the condition 1-1-2-1 is satisfied.

Subsequently, as depicted in FIG. 21, the information processing apparatus 101 substitutes one for a variable k (step S2101). The information processing apparatus 101 substitutes callee_num_in_loop registered in info for a variable num (step S2102). The information processing apparatus 101 also substitutes callee_list_in_loop registered in info for an array variable list (step S2103).

The information processing apparatus 101 then determines whether k is less than num (step S2104). If k is less than num (step S2104: YES), the information processing apparatus 101 duplicates the function corresponding to list[k] to callee and the caller of callee (step S2105). The case of “YES” at step S2104 represents a case where the condition 1-1-1 is satisfied. The information processing apparatus 101 increments k (step S2106) and transitions to the operation at step S2104.

On the other hand, if k is equal to or greater than num (step S2104: NO), in FIG. 19, the information processing apparatus 101 increments j (step S1907) and transitions to the operation at step S1906.

In FIG. 20, if the value of has_loop is false (step S2006: NO) or if the value of is_ref is false (step S2008: NO), the information processing apparatus 101 transitions to the operation at step S1007.

In FIG. 19, if j is not equal to or less than callee_num (step S1906: NO), the information processing apparatus 101 increments i (step S1908) and transitions to the operation at step S1904.

As described above, the information processing apparatus 101 duplicates the third function and the external function present in the loop process of the external function when the condition 1-1-1 is satisfied or/and duplicates the external function when the condition 1-1-2-1 is satisfied. As a result, if the duplicated function is subjected to inline expansion, the information processing apparatus 101 increases the possibility of facilitating the loop optimization and may increase the possibility of improving the execution performance of the executable file at the same time.

The information processing apparatus 101 may perform inline expansion based on the caller function of the external function and the duplicated function. By performing the inline expansion of the external function possibly leading to an improvement in execution performance in this way, the execution performance of the executable file may be improved.

When the condition 1-1-1 is satisfied, the information processing apparatus 101 may duplicate the third function present in the loop process of the external function into the file defining the external function. As a result, if the third function is subjected to the inline expansion, the information processing apparatus 101 may improve the execution performance of the executable file.

The compiling management method described in the present embodiment may be implemented by executing a program prepared in advance on a computer such as a personal computer or a workstation. This compiling program is recorded on a computer readable recording medium such as a hard disk, a flexible disk, a Compact Disc-Read Only Memory (CD-ROM), or a Digital Versatile Disk (DVD) and is read out from the recording medium by the computer and executed. This compiling program may be distributed through a network such as the Internet.

However, according to the prior arts, it is difficult to determine which function should be duplicated to a caller file so as to facilitate the inline expansion at the time of compiling. For example, if duplication is performed for every function, optimization is also performed for duplicated functions, resulting in an increase in translation time. Additionally, the number of assembler instructions is increased by the number of duplicated functions and, since the assembler instructions are arranged in a code area of an object code, the code area of the object code increases. Therefore, as the number of duplicated functions becomes larger, the code area of the object code is further enlarged. Thus, duplicating a function to facilitate the inline expansion is in a trade-off relationship with a size of an executable file obtained by compiling.

The embodiment of the present invention produces an effect in that a suitable function may be duplicated to a caller file at the time of compiling.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor configured to determine, when a first file among multiple files is compiled, whether a first function defined in the first file calls a second function that includes a loop process, the second function being defined in a second file this is among the multiple files and different from the first file, wherein
the processor executes at least one of:
duplicating the second function and a third function into the first file, when determining that the first function calls the second function and a call to the third function defined in any of the multiple files is present in the loop process, and
duplicating the second function into the first file, when determining that the first function calls the second function and a pointer type dummy parameter of the second function is referred to within the loop process.

2. The information processing apparatus according to claim 1, wherein
the processor performs inline expansion of the duplicated function based on the duplicated function and the first function.

3. The information processing apparatus according to claim 1, wherein
the processor further duplicates the third function into the second file, when determining that the first function calls the second function and a call to the third function is present in the loop process.

4. A compiling management method comprising:
determining, by a processor when a first file among multiple files is compiled, whether a first function defined in the first file calls a second function that includes a loop process, the second function being defined in a second file this is among the multiple files and different from the first file; and
at least one of:
duplicating, by the processor, the second function and a third function into the first file, when at the determining, the processor determines that the first function calls the second function and a call to the third function defined in any of the multiple files is present in the loop process, and
duplicating, by the processor, the second function into the first file, when at determining, the processor determines that the first function calls the second function and a pointer type dummy parameter of the second function is referred to within the loop process.

5. A non-transitory, computer-readable recording medium storing therein a compiling program that causes a computer to execute a process comprising:
determining, when a first file among multiple files is compiled, whether a first function defined in the first file calls a second function that includes a loop process, the second function being defined in a second file this is among the multiple files and different from the first file; and
at least one of:
duplicating the second function and a third function into the first file, when at the determining, the processor determines that the first function calls the second function and a call to the third function defined in any of the multiple files is present in the loop process, and
duplicating the second function into the first file, when at determining, the processor determines that the first function calls the second function and a pointer type dummy parameter of the second function is referred to within the loop process.
